(19) United States
(12) Patent Application Publication
(10) Pub. No.: US 2021/0117917 A1
(43) Pub. Date: Apr. 22, 2021

(54) SYSTEM AND METHOD FOR PRIORITIZED CONSTRUCTION

(71) Applicant: Jingoli Power, LLC, Lawrenceville, NJ (US)

(72) Inventor: PETER MATHEW OSWALD, Winter Haven, FL (US)

(73) Assignee: Jingoli Power, LLC, Lawrenceville, NJ (US)

(21) Appl. No.: 16/659,854

(22) Filed: Oct. 22, 2019

(51) Int. Cl. G06Q 10/08; G06Q 50/08; G06Q 30/06

(52) U.S. Cl. CPC G06Q 10/0875; G06Q 30/0603; G06Q 50/08

(57) ABSTRACT

A system and method enable a person to visually identify sites where construction of an object or other activity can occur. The method involves associating with each of a plurality of sites a corresponding object that is to be constructed or other activity is to occur, and a priority. Objects are formed from items defined in a catalog; The method includes visually outputting a report that includes, for one or more of the sites, an availability of the various items that are needed at the one or more sites. The availability is representative of a potential that a corresponding object can be built or other activity can occur at a given site. If the priority of a site is changed, an updated report is generated that includes an updated availability representative of a potential that a corresponding object can be built or other activity can occur at a particular site.

### BACKGROUND

### 1. Field

The disclosed and claimed concept relates generally to methodologies and systems for construction or other activities and, more particularly, to an improved system and method for prioritized construction of one or more objects or other activities at a plurality of sites.

### 2. Related Art

Numerous types of construction, assembly, installation, and other projects are known to exist in the world. The logistics involved with any such project can be extensive and complex, depending upon the extent of the number of items that are required and the complexity of the construction, assembly, etc. Such projects can be especially complex if the overall project involves, for instance, a plurality of different sites that are physically separated from one another by various geographic distances. Other complexities exist when each site has differing site requirements that can involve environmental concerns, differences among the objects that are to be installed or constructed, etc., at the various sites. Further complexity can be exist depending upon the availability of the various items that may be used to form the various objects that are to be constructed, assembled, or installed at the various sites. Still further complexity can be involved when the project involves a series of installations that involve some type of a sequential aspect, such as wherein a pipeline is installed between two locations, and the project involves various installations at various sites that are spaced along a route between the two locations.

Previous attempts at optimizing the availability of resources such as equipment labor, and items that are available for use in such installations at such sites have met with limited success. Improvements thus would be desirable.

### SUMMARY

An improved method and an improved system in the form of a computerized device enable a person to visually identify one or more sites from among a plurality of sites where construction of an object or other activity can occur. The method involves associating with each of a plurality of sites a corresponding object that is to be constructed, installed, or deployed at the site and also assigning to each such site a priority. Each such object is to be formed from one or more items from among a plurality of items that are defined in a catalog. The method further includes visually outputting with the computerized device a report in the form of a printout or the like that includes, for one or more of the sites, an availability of the various items that are needed at the one or more sites. The availability is representative of a potential that a corresponding object can be built at a given site. If the priority of a site is changed, an updated report is generated that includes an updated availability. The updated availability is representative of a potential that a corresponding object can be built on a particular site.

Accordingly, an aspect of the disclosed and claimed concept is to provide a method and system for managing a project, wherein the project involves a number of objects that are to be constructed from a number of items or other activities are to occur at a number of sites. As employed herein, the expression “a number of” and variations thereof shall refer broadly to any non-zero quantity, including a quantity of one.

Another aspect of the disclosed and claimed concept is to provide such a method and system wherein the various sites each have a priority that is signed thereto, and wherein the various priorities that have been assigned to the sites are taken into account when setting forth the various availabilities as to the various sites.

Another aspect of the disclosed and claimed concept is to provide an improved system and method wherein the priority that has been assigned to such a site can be increased or decreased, and an updated report can be generated in which updated availabilities are output, wherein the various updated availabilities have been modified based upon the adjusted priority.

Another aspect of the disclosed and claimed concept is to enable the outputting of a report that enables a person to visualize various availabilities that are representative of the various potentials that corresponding objects can be built or other activities can occur at various sites.

Accordingly, an aspect of the disclosed and claimed concept is to provide an improved method of employing a computerized device having a storage to enable a person to visually identify one or more sites from among a plurality of sites where construction of an object can occur. The method can be generally stated as including defining in the storage the plurality of sites, defining in the storage a catalog that can be generally stated as including, a plurality of items, defining in the storage a number of objects, specifying each object of at least some of the number of objects as requiring a predetermined required quantity of each of at least a subset of the items from among the plurality of items, associating with each site a corresponding object of the number of objects that is to be constructed at the site, assigned a priority to each of at least a subset of the plurality of sites, and visually outputting with the computerized device a report that includes for at least a first site from among the at least subset of the plurality of sites an availability of at least some of the items from among the at least subset of the items, the availability being representative of a potential that the corresponding object can be built on the at least first site.

Another aspect of the disclosed and claimed concept is to provide an improved computerized device structured to enable a person to visually identify one or more sites from among a plurality of sites where construction of an object can occur. The computerized device can be generally stated as including a processor apparatus that can be generally stated as including a processor and a storage, an input apparatus structured to provide input signals to the processor apparatus, an output apparatus structured to receive output signals from the processor apparatus, the storage having stored therein the plurality of sites, a catalog that that can be generally stated as including a plurality of items, and a number of objects wherein each object of at least some of the number of objects is specified as requiring a predetermined required quantity of each of at least a subset of the items from among the plurality of items, each site having associated therewith a corresponding object of the number of objects that is to be constructed at the site, the storage having stored therein a number of routines in the form of instructions which, when executed on the processor, cause the computerized device to perform operations that can be generally stated as including detecting a priority assigned to each of at least a subset of the plurality of sites, and visually outputting with the computerized device a report that includes for at least a first site from among the at least subset of the plurality of sites an availability of at least some of the items from among the at least subset of the items, the availability being representative of a potential that the corresponding object can be built on the at least first site.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved system in accordance with the disclosed and claimed concept and in the exemplary form of an improved computing device;

FIG. 2 is a depiction of a site table that is stored in a storage that is used by the computerized device;

FIG. 3 is a depiction of a catalog of items that is stored in the storage;

FIG. 4 is a depiction of an object table that is stored in the storage;

FIG. 5 is a depiction of an exemplary report that is output by the computerized device of FIG. 1 and that includes a number of availabilities, with the availabilities being representative of the potential that a corresponding object can be built or that a given activity can occur at a given site;

FIG. 6 is an updated report that is similar to the report of FIG. 5, except that it reflects updated availabilities that are altered based upon a change in a priority that has been assigned to a site; and

FIG. 7 is a flowchart depicting certain aspects of an improved method in accordance with the disclosed and claimed concept.

Similar numerals refer to similar parts throughout the specification.

### DESCRIPTION

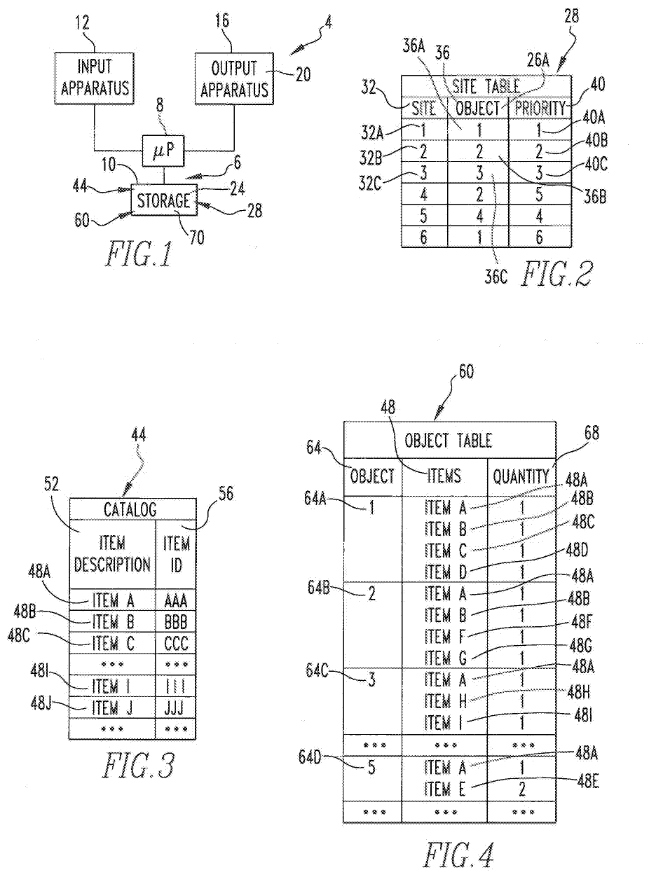

An improved computerized device 4 in accordance with the disclosed and claimed concept is depicted in a schematic fashion in FIG. 1. The computerized device 4 is the exemplary embodiment of a system that is advantageously usable to enable a person to visualize various availabilities, wherein each such availability is representative of the potential that a corresponding object can be built or some other activity can be completed at a site. It is noted that expressions such as “construction” and variations thereof, and “built” and variations thereof, are intended to be merely exemplary and are intended to be broadly representative of any project that can be completed at a site in accordance with an overall project, and thus can include any of a variety of activities that can occur at sites such as construction, installation, upgrading of equipment or software or both, assembly, and the like without limitation. It is also understood that the aforementioned “availability” can be pre-defined in any fashion, such as the installation of a substrate at a given site that will be subjected to future additional construction, and thus need not necessarily refer to all of the activity that might ultimately occur at any given site, and rather can refer merely to a stage of activity, depending upon the way in which the various activities are pre-defined and the needs of the particular application.

The computerized device 4 can be said to include a processor apparatus 6 that includes a processor 8 and a storage 10 that are in communication with one another. The storage 10 in the depicted exemplary embodiment is indicated as being a part of the computerized device 4, such as being resident thereon, such as in the nature of a handheld electronic device, but it is understood that the storage 10 can include not only storage that is resident on the computerized device 4 but also remote storage that is available to the computerized device, such as the way in which remote storage can be made available to the computerized device 4 via wireless and wired communication networks. The computerized device further includes an input apparatus 12 that provides input signals to the processor 8 and an output apparatus 16 that receives output signals from the processor 8 and responsively generates outputs in any of a variety of fashions. In the depicted exemplary embodiment, the output apparatus 16 includes a visual display 20 that can provide visual output thereon, although any of a variety of other output devices such as printers and other devices can be employed without departing from the spirit of the instant disclosure.

The storage 10 has stored therein a number of routines 24 that are in the nature of instructions which, when executed on the processor 8, cause the computerized device 4 to perform various operations such as are set forth elsewhere herein. The storage 10 can refer to storage structures such as RAM, ROM, EPROM, FLASH, and the like without limitation, and it is reiterated that storage devices may be resident on the computerized device 4 and may likewise include storage that is accessible by the computerized device 4 without necessarily being resident thereon.

The storage 10 further has stored therein a set of data that includes a site table 28 such as is depicted generally in FIG. 2 and which includes a plurality of sites that are each indicated generally at the numeral 32, and three of which are indicated at the numerals 32A, 32B, and 32C, any of which may be collectively or individually referred to herein with the numeral 32. The site table 28 further includes a plurality of objects that are indicated generally at the numeral 36, and three of which are indicated at the numerals 36A, 36B, and 36C, any of which may be collectively or individually referred to herein with the numeral 36. The site table 28 further has stored therein a plurality of corresponding priorities that are indicated generally at the numeral 40, and three of which are indicated at the numerals 40A, 40B, and 40C, any of which may collectively or individually referred to herein with the numeral 40.

The site table 28 is defined in the storage 10 such that each site 32 has a corresponding object 36 that is intended to be built thereon, and each site 32 additionally has a priority 40 assigned thereto. For instance, the site 32A is intended to have an object 36A built thereon, and the building of the object 36A at the site 32A is assigned a corresponding priority 40A. The sites 32, the corresponding objects 36, and the corresponding priorities 40 are defined in the site table 28 which is, itself, stored in the storage 10 for access by the processor 8 when the routines 24 are being executed on the processor 8. It is reiterated that the concepts employed herein of the objects 36 being built at the sites 32 is merely an example of any type of activity or set of activities that can be defined as one of the objects 36 and that is desired to occur at a corresponding one of the sites 32. The references herein to construction and building are thus not intended to be limiting and are intended to refer to any type of activity without limitation.

The priorities 40 are each relative to one another and can be characterized with whole numbers, fractions, decimal values, etc., and need not necessarily all be different than one another, such as when a pair of sites 32 might be given the same priority 40 based upon various needs. It is understood that the priorities 40 can advantageously be changed, such as via an input on the input apparatus 12, in order to cause the processor apparatus 6 to generate and to cause the output apparatus 16 to output a new visual output that is based at least in part upon the altered priority, as will be set forth in greater detail elsewhere herein.

The storage 10 also has a catalog 44 stored therein that includes a plurality of items that are indicated at the numerals 48A, 48B, 48C, 48D, 48E, 48F, 48G, 48H, 48I, and 48J, which may be collectively or individually referred to herein with the numeral 48. The items 48 each include, in the depicted exemplary embodiment, an item description 52 and an item ID 56 that can be employed in any of a variety of fashions to describe each such item 48. The items 48 that are defined in the catalog 44 are usable in various combinations and quantities to construct the objects 36 at the various sites 32.

Further in this regard, the storage 10 has stored therein an object table 60, with the object table 60 having pre-defined therein a plurality of objects, four of which are indicated at the numerals 64A, 64B, 64C, and 64D, and which may collectively or individually referred to herein with the numeral 64. The exemplary object table 60 only expressly depicts four of the objects 64, it being understood that the object table 60 potentially can and likely will include many more objects 64. The same can be said for the catalog 44 which potentially can and likely will include many more items 48. As can be understood from FIG. 4, each of the objects 64 is indicated in the object table 60 as including, i.e., as being constructed from, one or more of the items 48. The object table 60 further specifies at the numeral 68 a predetermined required quantity of each such item 48 to complete the object 36. For instance, the object 64A is formed from four items 48A, 48B, 48C, and 48D, with the corresponding quantity 68 being a quantity of one of each such item 48. In this regard, it is understood that the items 48 need not necessarily refer to physical items, and rather can refer to anything such as a number of hours of operating time that are needed on an earthmoving machine, the availability of a software license, or the like without limitation.

The storage 10 further has stored therein an item data set 70 that reflects the inventory of items 48 that are associated with the project. The item data set 70 can be in any of a variety of forms and can be updated when additional items 48 are received, when items 48 in the inventory are delivered to the various sites 32, and the like. Whenever a number of the items 48 are physically received, such as to a laydown yard, such items 48 can also be virtually received via a bill of lading, by way of example, and the item data set 70 is then automatically updated to reflect the amounts and the locations of the various items 48 that have been received, as evidenced by the bill of lading and otherwise. The item data set 70 can be stored as part of the catalog 44 or can be stored separately without departing from the spirit of the instant disclosure. The item data set 70 can include, for instance, a quantity-on-hand of each of the items 48, which would be representative of the quantity of each such item 48 that is physically situated in the laydown yard and that is available to be issued to any of a variety of the sites 32. The item data set 70 further likely would include the quantity of each such item 48 that has already been issued to each such site 32. Whenever an item 48 that is on-hand in the laydown yard is being issued to a site 32, the quantity of each item being is decremented from the quantity-on-hand category, and the amounts of issued items are incremented with respect to the various sites 32 to which the items 48 where issued. Other variations will be apparent.

The routines 24 employ the site table 28, the catalog 44, the object table 60, and the item data set 70 in order to generate and visually depict a report 72 such as is depicted generally in FIG. 5. For instance, based at least in part upon the priorities 40 that are assigned to the various sites 32, the exemplary report 72 lists the sites 32 in order of, for instance, their priority 40 and includes for each such site 32 the various item descriptions 52 and the item IDs 56 of the various items 48 that are needed at each such site 32 in order to build the corresponding object 36 at each such site 32. These are indicated in columns in the report 72 with the sites 32 being output in order of, for example, their relative priority 40, from top to bottom in the report 72. The routines 24 can alternatively employ other criteria to rank order the sites 32 in the report 72.

The report 72 additionally includes a column that indicates a quantity required, as at the numeral 76, which is a quantity of each such item 48 that has been pre-defined in the object table 60 that will be needed for each such object 64 that will permit the object 64 to be assembled at the corresponding site 32. The report 72 further includes a column that indicates a quantity issued, as at the numeral 80, of each such item 48 and is representative of the quantity of each such item 48 that has actually been delivered to the corresponding site 32. It is noted that the “quantity issued” potentially could include items 48 that have been issued from the laydown yard but that have not yet been physically delivered to a site 32 since they are in transit from the laydown yard to the sits 32, depending upon then needs of the particular application.

The report additionally includes a column that indicates a quantity-on-hand, as at the numeral 84, which is representative of the quantity of each item 48 that is currently in existence at a laydown yard that is indicated at the numeral 86 in FIG. 5. The use of the numeral 86 in the report 72 of FIG. 5 is intended to refer to the fact that the quantities of such items 48 are in existence at the laydown yard 86 and are available for issuance to the various sites 32.

The report 72 advantageously also includes a column that indicates a priority-allocated quantity, as at the numeral 88, which is output with respect to each item 48 as to each site 32 in the report 72. For the sake of completeness, it is noted that the exemplary report 72 that is depicted in FIG. 5 does not necessarily include a visual output for each of the sites 32 and is intended to be merely representative of one type of visual output that is possible with the advantageous method and system that are described herein. The priority-allocated quantity 88 of any given item 48 as to any given site 32 refers to the quantity of that particular item 48 which, for any given site 32, has already been allocated to another site 32 having a relatively higher priority 40. As such, it can be seen that for the highest priority site 32, which is indicated in FIG. 1 as being “SITE 1”, the priority-allocated quantity 88 for each of the items 48 of the corresponding object 36 that is to be built at “SITE 1” is “0”. This is because no other site 32 has a priority higher than that of the site 32 to which is assigned the highest priority, and thus no item 48 for “SITE 1” can be indicated as being priority-allocated to a higher-priority site 32. However, for the site 32 having the next highest priority which, in the depicted exemplary embodiment, is designated as “SITE 2”, two of its items 48, i.e., “ITEM A” and “ITEM B” are indicated as having a priority-allocated quantity 88 of “1” in each case since one instance of each of “ITEM A” and “ITEM B” has already been allocated to another site 32 which, in the depicted exemplary embodiment, is “SITE 1” and which has the relatively highest priority in the exemplary report 72 of FIG. 5. In this regard, it can be understood that the item 48 referred to as “ITEM A” with respect to “SITE 2”, which is not the highest priority site, is priority-allocated to a higher priority site, namely “SITE 1”, but as to “SITE 1”, the “ITEM A” is not priority-allocated to any other site, and this is indicated in the report 72 of FIG. 5. This demonstrates that an item 48 might be priority-allocated with respect to a relatively lower priority site 32 but might not be priority-allocated with respect to a higher priority site 32.

The report 72 further includes a column that indicates a quantity available, as at the numeral 92, which is calculated for each item 48 at each site 32 by subtracting the priority-allocated quantity of that item 48 as to that site 32 from the quantity-on-hand 84 of that same item 48 as to the same site 32. This is especially demonstrated with regard to “ITEM A” at “SITE 2” wherein the quantity-on-hand 84 is “2”, the priority-allocated quantity 88 is “1” and thus the quantity available 92 is 2−1=1 meaning that the quantity available 92 for “ITEM A” at “SITE 2” is “1”. On the other hand, it is noted that the quantity available 92 of the same item 48, i.e., “ITEM A” as to “SITE 1” “2” due to the relatively higher priority of “SITE 1”. It is also noted that if the sum that results from subtracting the priority-allocated quantity of an item 48 as to a site 32 from the quantity-on-hand 84 of the item 48 as to the site 32 is a negative quantity, the report merely indicates “0” rather than the negative amount. This is done to simplify the content of the report 72 and to make its content more easily understandable by the person viewing the report 72.

The report 72 additionally includes a column that indicates an outstanding site requirement, as at the numeral 96, which is calculated by subtracting the quantity required 76 from the quantity issued 80. The outstanding site requirement 96 is representative of an unmet need at any site 32 of any object 48 that is still required at the site 32 in order to build the corresponding object 36.

By providing both the quantity-on-hand 84 and the outstanding site requirement 96, a person can view the quantity-on-hand 84 in the context of the outstanding site requirement 96 and can determine therefrom whether or not the corresponding object 6 that is to be built at any given site 32 is capable of being built at that site 32. In this regard, the outputting of the quantity-on-hand 84 and the outstanding site requirement 96 constitutes the visual outputting of an availability of the various items 48 that are needed to build the corresponding object 36 at the site 32. As such, this visually-output availability, as evidenced by the visually-output quantity-on-hand 84 and the visually-output outstanding site requirement 96, constitutes a visually-output representative of a potential that a corresponding object 36 can be built at a given site 32.

For example, a person viewing the report 72 of FIG. 5 might observe that for “SITE 1” and “SITE 2”, the item 48 designated “ITEM B” has a quantity-on-hand 84 of “0” but that an outstanding site requirement 96 at both such items 32 is “1”, which means that the quantity-on-hand 84 of that particular item 48 is insufficient to meet the outstanding site requirement 96 at both sites 32, which indicates that the corresponding object 36 cannot be built at “SITE 1” and likewise cannot be built at “SITE 2”. However, the person viewing the report 72 would notice that for “SITE 3”, the quantity-on-hand 84 of each of the corresponding items 48 is equal to or in excess of the outstanding site requirement 96 of each such item 48, meaning that sufficient quantities of the needed items 48 for the corresponding object 36 at “SITE 3” actually do exist at the laydown yard 86. However, even though the quantity-on-hand 84 for “ITEM A” as to “SITE 3” is “2”, the quantity available 92 for “ITEM A” as to “SITE 3” is nevertheless “0”. This indicates that the existing priority that is assigned to “SITE 3” is preventing the corresponding object 36 from being constructed at “SITE 3” since the priority-allocated quantity of “ITEM A” as to “SITE 3” is “2”. Upon ascertaining this, the person may responsively adjust the priority of “SITE 3” to be relatively higher, by increasing the priority of “SITE 3” and/or by reducing the priority of “SITE 1” and/or “SITE 2”. In this regard, the input apparatus 12 includes a user interface whereby an increase in the priority of one site 32 to be higher than a number of other sites 32 will automatically reduce the priority of the other sites 32 to be lower than that of the one site in order to avoid the person having to individually reduce the priorities of all of the other sites 32. Other variations will be apparent.

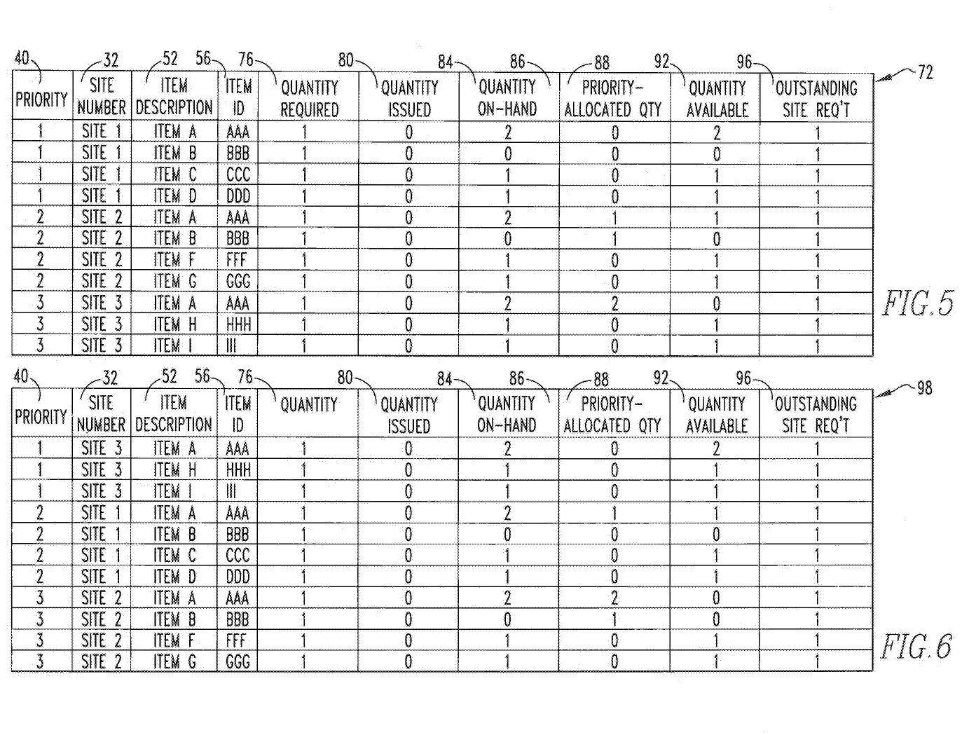

Upon detecting a change in priority of one of the sites 32, the routines 24 responsively trigger the outputting of an updated report such as indicated at the numeral 98 in FIG. 6. The updated report 98 of FIG. 6 demonstrates that the site 32 referred to as “SITE 3” is now assigned the highest priority 40 from among the various sites 32, i.e., a priority of “1” and that the quantity available 92 as to all of the items 48 that are required to build the corresponding object 36 at that site 32 are equal to or greater than the outstanding site requirement 96 at that site 32. This indicates that the corresponding object 36 can be built at “SITE 3” now that the priority 40 of “SITE 3” has been increased.

The updated report 98 in the depicted exemplary embodiment has the same columns as the original report 72, except that the relevant values for prioritized-allocated quantity 88 and quantity available 92 have been updated to reflect the change in priority of “SITE 3”. This is because the increase in the priority of “SITE 3” results in the item “ITEM A” as to “SITE 3” no longer being priority-allocated in favor of each of “SITE 2” and “SITE 1”. In this regard, it can be understood from the report 72 that “SITE 3” would also have been indicated as being buildable even if its priority had been changed to be greater than that of “SITE 2” but still less than that of “SITE 1” since only one of the “ITEM A” was required in order to complete the corresponding object 36 at “SITE 3”, and this could be accomplished even if one of the “ITEM A” was still priority-allocated to “SITE 1”.

The updated report 98 of FIG. 6 thus depicts an updated availability that the corresponding object 36 can be built at “SITE 3”. Such an updated availability is demonstrated by the quantity-on-hand 84 and the quantity available 92 as to each item 48 for “SITE 3” being equal to or exceeding each corresponding outstanding site requirement 96 at that site 32.

It is understood that the report 72 and the updated report 98 present an exemplary depiction of the way in which the availability of one of the objects 36 to be built at one of the sites 32 is visually indicated. It is understood that any quantity of sites 32 and any quantity of objects 36 with any quantity of items 48 can be pre-defined in the storage 10 depending upon the needs of the given application. It thus can be seen that the outputting of the availability in the report 72 and the updated report 98 of the corresponding object 36 to be built at a site 32 is highly advantageous since it permits a person to visually ascertain whether or not a given object 36 can be constructed based upon items 48 that are already on hand, by way of example, particularly when such construction is prioritized. This improves efficiency of resources such as labor, shipping, and inventory in order to improve the efficiency of an activity such as building at the various sates 32.

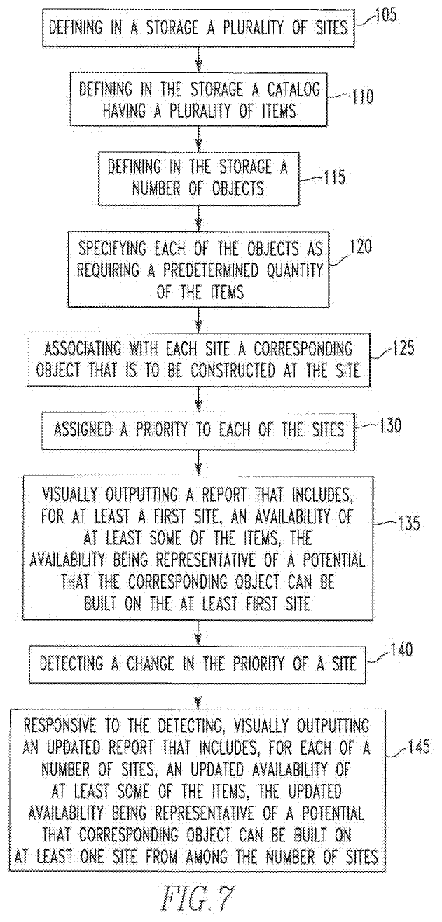

Certain aspects of an improved method in accordance with the disclosed and claimed concept are depicted generally in FIG. 7. Processing can begin, as at 105, where the plurality of sites 32 are defined in the storage 10, such as through the use of the site table 28. Processing continues, as at 110, where the various items 48 are defined in the storage 10, such as through the use of the catalog 44. Processing can continue, as at 115, where the objects 36 are defined in the storage 10, such as through the use of the object table 60. Each of the objects 36 is specified, as at 120, as requiring a predetermined quantity of certain of the items 48. It is understood that the defining of the sites 32, objects 36, and items 48 can be done in any of a variety of fashions in any of a variety of orders. It is also understood that the item data set 70 is stored in the storage 10 and is periodically updated.

Processing can continue, as at 130, where a priority 40 is assigned to each of the sites 32. Processing can then continue, as at 135, where the routines 24 access the item data set 70 and the various data such as the site table 28, the catalog 44, and the object table 60 in order to generate and visually output a report, such as the report 72, that includes an availability that, for a given site 32, is representative of a potential that the corresponding object 36 can be built at that site 32. As noted, by providing both the quantity-on-hand 84 and the outstanding site requirement 96, the output apparatus 16 visually outputs this availability, and a person can ascertain this availability.

Depending upon the needs of the particular application, the routines 24 might detect, as at 140, a change in the priority 40 of each of one or more of the sites 32. Processing then continues, as at 145 where, responsive to the detecting of the change in priority 40, the routines 24 will generate and visually output an updated report, such as the updated report 98, as is depicted generally in FIG. 6. The updated report 98 includes an updated availability of the potential that a corresponding object 36 can be built at a given site 32. As noted hereinbefore, this is indicated by the quantity-on-hand 84 and the quantity available 92 with respect to the outstanding site requirement 96. It is also noted that the availability can be based upon the quantity available 92 and the outstanding site requirement 96 when the quantity available 92 is equal to or in excess of the outstanding site requirement. When the outstanding site requirement 96 is met by the quantity available 92 and the quantity-on-hand 84 (and for the highest priority site the quantity available 92 and the quantity-on-hand 84 will be equal in quantity), this indicates that the corresponding object 36 can be built at that site 32. Other benefits will be apparent.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A method of employing a computerized device having a storage to enable a person to visually identify one or more sites from among a plurality of sites where construction of an object can occur, the method comprising:
defining in the storage the plurality of sites;
defining in the storage a catalog that comprises a plurality of defining in the storage a number of objects;
specifying each object of at least some of the number of objects as requiring a predetermined required quantity of each of at least a subset of the items from among the plurality of items;
associating with each site a corresponding object of the number of objects that is to be constructed at the site;
assigned a priority to each of at least a subset of the plurality of sites; and
visually outputting with the computerized device a report that includes for at least a first site from among the at least subset of the plurality of sites an availability of at least some of the items from among the at least subset of the items, the availability being representative of a potential that the corresponding object can be built on the at least first site.

2. The method of claim 1, further comprising:
detecting a change in the priority of a site from among the at least subset of the plurality of sites; and
responsive to the detecting, visually outputting an updated report that includes or each of a number of sites from among the at least subset of the plurality of sites an updated availability of at least some of the items from among the at least subset of the items, the updated availability being representative of a potential that the corresponding object can be built on at least one site from among the number of sites.

3. The method of claim 1, further comprising visually outputting in the report an outstanding site requirement that is representative of an unmet need at the at least first site of each of a number of items of the at least subset of the items of the corresponding object that is to be constructed at the at least first site.

4. The method of claim 3, further comprising visually outputting in the report the predetermined required quantity of each of the number of items of the corresponding object.

5. The method of claim 3, further comprising visually outputting in the report and in connection with the at least first site a priority-allocated quantity of an item of the number of items that is already allocated to one or more sites from among the plurality of sites other than the at least first site that each have a priority higher than that of the at least first site.

6. The method of claim 5, further comprising:
detecting as a change in priority at least one of:
a reduction in the priority of at least one site om among the one or more sites, and
an increase in the priority of the at least first site; and
responsive to the detecting, visually outputting in the report in connection with the at least first site an updated priority-allocated quantity of the item that is of a lesser magnitude based at least in part upon the change in priority.

7. The method of claim 5, further comprising visually outputting in the report a quantity-on-hand of the item that is representative of a quantity of the item that is available for issuance to the plurality of sites.

8. The method of claim 7, further comprising visually outputting in the report an available quantity of the item that is available for issuance to the at least first site and that is representative of the quantity-on-hand of the item minus the priority-allocated quantity of the item.

9. The method of claim 8, further comprising visually outputting in the report in connection with a given site of the plurality of sites as the available quantity of a given item of the plurality of items a quantity of zero when the priority-allocated quantity of the given item as to the given site exceeds the quantity-on-hand of the given item.

10. The method of claim 1, further comprising visually outputting in connection with the at least first site as the availability of the at least some of the items:
a quantity-on-hand of each of the at least some of the items that is representative of a quantity of each of the at least some of the items that is available for issuance to the plurality of sites; and
an outstanding site requirement that is representative of any unmet need at the at least first site as to any of the at least some of the items.

11. The method of claim 1, further comprising receiving a number of data sets that are each representative a quantity of each of a number of items of the plurality of items and a location at which the quantity is situated, each location being one of:
a site of the plurality of sites; and
a laydown yard from which the quantity can be dispatched to a site of the plurality of sites.

12. A computerized device structured to enable a person to visually identify one or more sites from among a plurality of sites where construction of an object can occur, the computerized device comprising:
a processor apparatus comprising a processor and a storage;
an input apparatus structured to provide input signals to the processor apparatus;
an output apparatus structured to receive output signals from the processor apparatus;
the storage having stored therein the plurality of sites, a catalog that comprises a plurality of items, and a number of objects wherein each object of at least some of the number of objects is specified as requiring a predetermined required quantity of each of at least a subset of the items from among the plurality of items, each site having associated therewith a corresponding object of the number of objects that is to be constructed at the site;
the storage having stored therein a number of routines in the form of instructions which, when executed on the processor, cause the computerized device to perform operations comprising:
detecting a priority assigned to each of at least a subset of the plurality of sites; and
visually outputting with the computerized device a report that includes for at least a first site from among the at least subset of the plurality of sites an availability of at least some of the items from among the at least subset of the items, the availability being representative of a potential that the corresponding object can be built on the at least first site.

13. The computerized device of claim 12, wherein the operations her comprise:
detecting a change in the priority of a site among the at least subset of the plurality of sites; and
responsive to the detecting, visually outputting an updated report that includes for each of a number of sites from among the at least subset of the plurality of sites an updated availability of at least some of the items from among the at least subset of the items, the updated availability being representative of a potential that the corresponding object can be built on at least one site from among the number of sites.

14. The computerized device of claim 12, wherein the operations further comprise visually outputting in the report an outstanding site requirement that representative of an unmet need at the at least first site of each of a number of items of the at least subset of the items of the corresponding object that is to be constructed at the at least first site.

15. The computerized device of claim 14, wherein the operations further reprise visually outputting in the report the predetermined required quantity of each of the number of items of the corresponding object.

16. The computerized device of claim 14, wherein the operations further comprise visually outputting in the report and in connection with the at least first site a priority-allocated quantity of an item of the number of items that is already allocated to one or more sites from among the plurality of sites other than the at least first site that each have a priority higher than that of the at least first site.

17. The computerized device of claim 16, wherein the operations further comprise:
detecting as a change in priority at least one of:
a reduction in the priority of at least one site from among the one or more sites, and
an increase in the priority of the at east first site; and
responsive to the detecting, visually outputting in the report in connection with the at least first site an updated priority-allocated quantity of the item that is of a lesser magnitude based at least in part upon the change in priority.

18. The computerized device of claim 16, wherein the operations further comprise visually outputting in the report a quantity-on-hand of the item that is representative of a quantity of the item that is available for issuance to the plurality of sites.

19. The computerized device of claim 18, wherein the operations further comprise visually outputting in the report an available quantity of the item that is available for issuance to the at least first site and that is representative of the quantity-on-hand of the item minus the priority-allocated quantity of the item.

20. The method of claim 12, wherein the operations further comprise visually outputting in connection with the at least first site as the availability of the at least some of the items:
a quantity-on-hand of each of the at least some of the items that is representative of a quantity of each of the at least some of the items that is available for issuance to the plurality of sites; and
an outstanding site requirement that is representative of any unmet need at the at least first site as to any of the at least some of the items.
